(19) United States
(12) Patent Application Publication
(10) Pub. No.: US 2007/0006496 A1
(43) Pub. Date: Jan. 11, 2007

(54) Moveable solar-powered address display with user-supplied indicia

(76) Inventors: John W. Jones, Richmond, IN (US); Roberta Jones, Richmond, IN (US)

Correspondence Address: Galasso & Associates, LP, P.O. Box 26503, Austin, TX, 78755-0503, US

(21) Appl. No.: 11/175,245

(22) Filed: Jul. 6, 2005

(51) Int. Cl. G09F 13/04

(52) U.S. Cl. 40/564; 40/575

(57) ABSTRACT

A self-contained and easily moveable solar-powered illuminated address display is provided comprising a compartment into which a translucent address display plate may be slid. Users can supply inexpensive indicia, such as numbers or letters, onto the address display plate to indicate an address or other information, by attaching stick-on indicia, drawing, painting, or printing them, or purchasing them in preconfigured forms. A solar panel supplies electrical power, which is stored in a battery, to supply a lighting means with power. When light is generated, it passes through the translucent address display plate, contrasting with areas marked by the indicia, so that the address may be read easily at night. An optional photo cell switch switches the power on or off according to lighting conditions. The solar-powered illuminated address display may be attached to a second surface, such as a wall or mailbox, by wood screws, machine screws, a chain, or magnets.

### FIELD OF THE DISCLOSURE

The invention relates generally to solar-powered illuminated address displays, and more particularly to a solar-powered illuminated address display that is easily moveable and that allows the user to easily add and change indicia such as numbers.

### BACKGROUND

Finding an unfamiliar house or other buildings can be extremely difficult, especially at night. Shrubbery can block the house's address number, or a house may have lighting that is so dim that the number cannot be seen, whether the number is on the side of the house, on the house's driveway, or on a special sign. Similarly, the house may be located at a considerable distance from the road so that the number cannot be read easily. Houses located in rural areas can be even harder to find. These houses may be situated at the end of long, possibly unmarked driveways. Other houses in rural areas may have no street lighting to illuminate any signs with numbers. The addresses for other buildings than houses are often difficult to read for similar reasons. Moreover, even address numbers on mail boxes or signs located near roads are often difficult to read because of poor lighting conditions, again especially at night.

These problems with the visibility of address numbers may make it difficult for police officers, firefighters, ambulance crews, cab drivers, pizza delivery people, and other visitors to find houses and other buildings quickly and conveniently.

Because of the problems with reading address numbers, techniques have been devised for illuminated address number displays, which may be powered by solar power when other sources of electricity are not available. For example, U.S. Pat. No. 5,522,540 for Surman provides a solar powered illuminated address number and mailbox structure. Although this apparatus is effective in using solar power to illuminate address numbers, it employs a complicated system of reflective tape attached along the polished edges both of the apparatus and of a transparent display device containing a set of preconfigured numbers, to achieve brilliance in the display. Moreover, the numbers on the transparent display device are fixed, may not be easily changed, and must be purchased as a preconfigured set, which may be expensive. Furthermore, the support that holds the transparent display device attaches to the mailbox by means of elongated channels or protuberances, so that the mailbox must be designed to receive these channels or protuberances.

Consequently, the user cannot easily move this apparatus to another location or change address the numbers. For example, a homeowner who moves to a new house could only move this apparatus by moving the whole mailbox, although the homeowner may want to locate a solar-powered number display at a different location at the new house, such as on a front wall. In addition, to change the displayed numbers the user would need to buy a new display device with the new numbers.

U.S. Pat. No. 6,708,876 for Shirah provides a solar-powered lighted mailbox in which a solar panel is mounted on the top of the mailbox and indicia numbers preconfigured on individual sections are inserted individually into a planar portion with tracks that is attached conventionally to the mailbox. This apparatus has many of the same disadvantages cited above; it is not easily moveable, cannot be located on walls and other surfaces besides mailboxes, and requires the user to buy preconfigured indicia such as numbers.

U.S. application 2003/0121541 for Hilton provides a solar-powered backlighted building and home identification system comprising an apparatus with downward projecting legs or stakes to be placed on or near the ground. The apparatus also comprises an indicia panel that slides into a frame with tracks and which may comprise a set of multiple preconfigured indicia or individual preconfigured indicia that are inserted individually. Although this apparatus is more moveable than the others cited above, it is not clearly designed for use on walls and on mailboxes or any surface other than the ground. The preconfigured indicia also must be purchased, making them potentially expensive.

Therefore, there is a need for a less complicated, less expensive, and easier to use apparatus that supplies solar-powered illumination for address displays, that is moveable to more surfaces, and that allows the user to supply indicia such as numbers through a wider range of methods.

### SUMMARY OF THE DISCLOSURE

The following explanation describes the present invention by way of example and not by way of limitation.

It is an aspect of the present invention to provide a solar-powered illuminated address display that is easily moveable to a wide array of surfaces.

It is another aspect of the present invention to provide a solar-powered illuminated address display that allows the user to easily add and change indicia such as numbers.

These and other aspects of the present invention will become readily apparent upon further review of the following specification and associated drawings. In accordance with the present invention, a self-contained and easily moveable solar-powered illuminated address display is provided comprising a compartment into which a translucent address display plate may be slid. Users can supply inexpensive indicia, such as numbers or letters, onto the address display plate to indicate an address or other information, by attaching stick-on indicia, drawing, painting, or printing them, or purchasing them in preconfigured forms. A solar panel supplies electrical power, which is stored in a battery, to supply a lighting means with power. When light is generated, it passes through the translucent address display plate, contrasting with areas marked by the indicia, so that the address may be read easily at night. An optional photo cell switch switches the power on or off according to lighting conditions. The solar-powered illuminated address display may be quickly attached to a second surface, such as a wall or mailbox, by wood screws, machine screws, a chain, or magnets.

### BRIEF DESCRIPTION OF THE DRAWINGS

The following embodiments of the present invention are described by way of example only, with reference to the accompanying drawings, in which:

FIG. 1 illustrates a three quarters view of a solar-powered illuminated address display;

FIG. 2 illustrates a front view of a address display plate with individual sections; and

FIG. 3 illustrates a front view of a solar-powered illuminated address display.

### DETAILED DESCRIPTION OF THE DRAWINGS

The following description of drawings is offered to illustrate the present invention clearly. However, it will be apparent to those skilled in the art that the concepts of the present invention are not limited to these specific details. Also, commonly known elements are shown in diagrams for clarity, as examples only and not as limitations of the present invention.

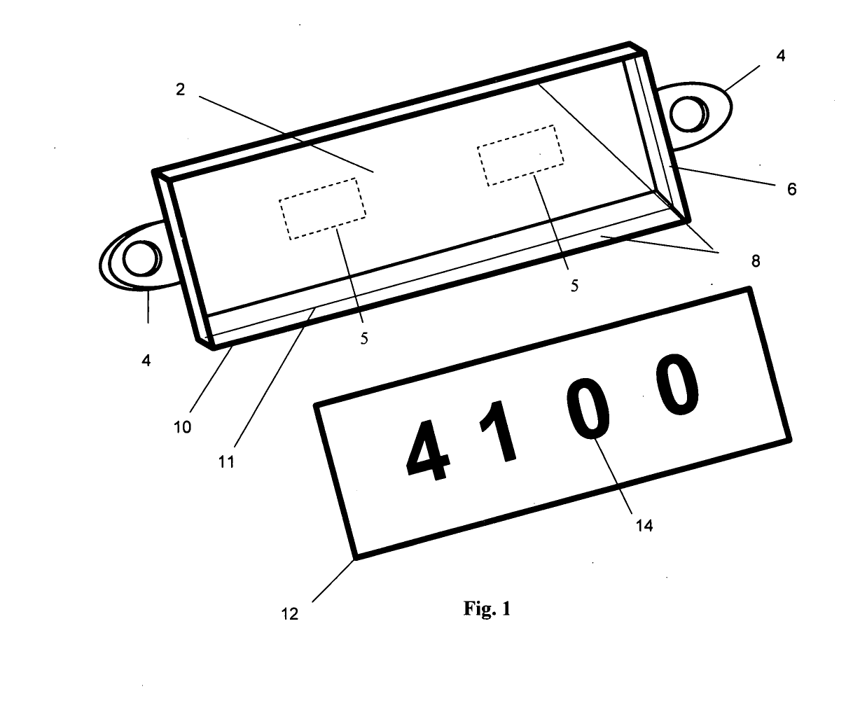

FIG. 1 illustrates a side view of a solar-powered illuminated address display in accordance with the present invention. The material for the solar-powered illuminated address display may be lightweight and should be long lasting and durable. For example, in an embodiment it may be constructed of impact-resistant thermoplastics such as polyethylene or polypropylene, which are recognized in the industry as being versatile, durable, and of high quality, and it may also contain corrosion-resistant metal and electrical elements. In embodiments, it may measure two and a half to three and a half inches in height and six to ten inches in length, with the depth dependant on the specific sizes of its internal components, explained below.

In an embodiment, the solar-powered illuminated address display comprises the following external elements:
An enclosing compartment 2,
Two rounded tabs with holes 4,
A side slot 6,
Two tracks 8,
Two outer ridges 10,
Two inner ridges 11,
An address display plate 12, and
Indicia 14.

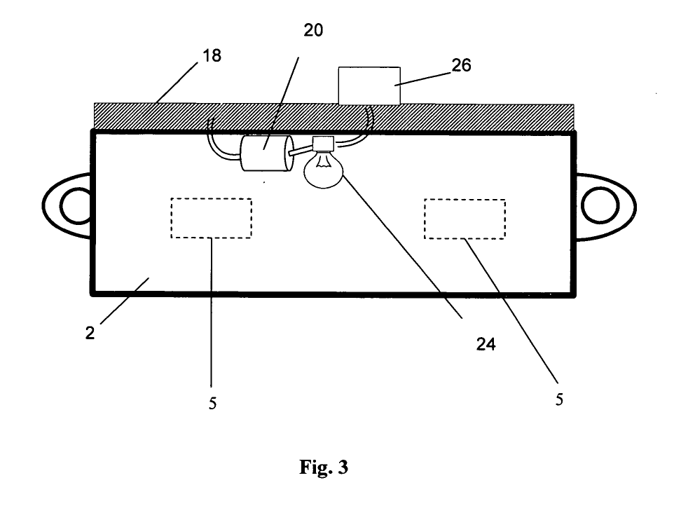

FIG. 3 illustrates the internal components of a solar-powered illuminated address display in an embodiment, comprising
A solar panel 18,
A battery 20,
A lighting means 24, and
An optional photo cell switch 26.

The enclosing compartment 2, shown in FIG. 1, may be lightweight and should be long lasting and durable. In an embodiment it may be constructed of impact-resistant thermoplastics, as described above. Two rounded tabs with holes 4 allow the enclosing compartment 2 to be attached by wood screws or machine screws to other surfaces. Thus, the solar-powered illuminated address display is a discrete unit that may be mounted on most surfaces, such as mailboxes and walls.

In another embodiment a chain may be attached to the enclosing compartment 2 through conventional attachment means. For example, a chain may be passed through the rounded tabs 4, so that the enclosing compartment 2 may be hung from surfaces, such as eaves or tree limbs, for still more convenience. In still another embodiment, magnets may be placed against the back wall of the enclosing compartment 2, so that the enclosing compartment 2 may be attached magnetically to a metal surface, for example to a metal mailbox.

A slide slot 6 provides an opening through which the address display plate 12 may be slid onto two tracks 8, one on the top of the enclosed compartment 2 and one on the bottom, where each track is formed between two outer ridges 10 and two inner ridges 11, at the top and bottom of the enclosed compartment 2. A user may thus slide the address display plate 12 fully and securely into the enclosing compartment 2.

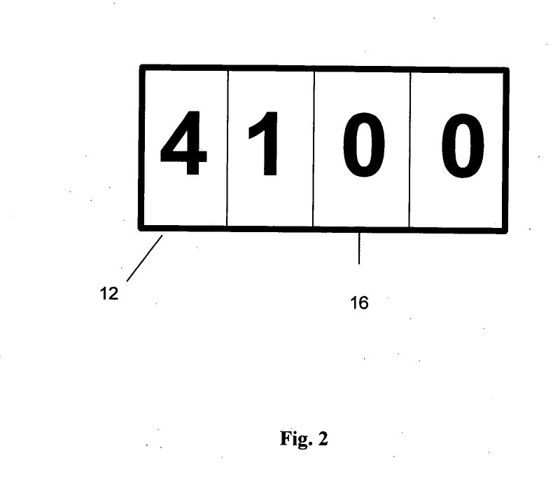

In an embodiment the address display plate 12 comprises a single lightweight and durable sheet of white, translucent plastic. The user may place indicia 14, such as stick-on numbers and letters, in desired colors to indicate the location's address or other information. For example, red stick-on numbers may be used that contrast effectively with the white plastic of the address display plate 12. When a lighting means is placed within the enclosing compartment 2, as explained below, the light generated flows through the white translucent plastic and is either blocked entirely be the stick-on indicia 14 or appears in the color of the indicia 14 if the indicia 14 are translucent. With red stick-on indicia 14, for example, the illuminated numbers would appear as red, and the background area, comprising the rest of the address display plate 12, would appear as white, making the address easy to read, especially at night. In other embodiments, other color schemes may be used for the indicia 14 and address display plate 12. In yet another embodiment, shown in FIG. 2, the address display plate 12 may comprise multiple independent sections 16.

Reflective material may optionally be placed on the back wall of the enclosing compartment 2 to enhance the effect of the lighting means. Moreover, the user may optionally apply indicia 14 to the address display plate 12 by other means, for example by user-marked indicia made by painting or drawing them on with or without stencils, or by printing them in appropriate sizes on printers.

In still another embodiment, the indicia 14 may be preconfigured on the address display plate 12, for example as incisions or colored elements. In another embodiment, plastic or metal numbers could be slid into grooves on the address display plate 12 as indicia 14.

As shown in FIG. 3, a solar panel 18, well known to those skilled in the art, is conventionally attached to the top of the enclosing compartment 2 and serves as the power source for the apparatus, so that electricity for illumination may be supplied to any location where there is sunlight during the day. A battery 20 attached conventionally inside the enclosing compartment 2 stores the electricity generated by the solar panel 18, so that electricity may be made available to a lighting means 24, for example a light bulb, also attached conventionally inside the enclosing compartment 2. Optionally, a photo cell switch 26, conventionally attached to the top of solar panel 18, may be used to automatically switch power off or on to the lighting means 24 in response to light conditions. As is well known to those skilled in the art, metal wires and fittings are used to make the electrical connections.

Use

The user would install the solar-powered illuminated address display quickly and easily wherever desired. For example, it could be screwed to the side of a front wall exposed to daylight. If the user moves to another house, the apparatus could be quickly unscrewed and then attached to a new location, for example to a mailbox. Moreover, users may employ inexpensive and easily obtained stick-on indicia to indicate addresses or other information on the apparatus, or may mark the indicia by painting them, drawing them, printing them, or by other means. Making changes in such indicia is typically easy and inexpensive. In all, the present invention's solar-powered illuminated address display is easily moveable and allows the user to easily add and change indicia.

The best dimensional relationships for the parts of the invention described above, including variations in form and use, will be readily apparent to those skilled in the art, and are intended to be encompassed by the present invention.

1-7. (canceled)

8. An illuminated address display, the illuminated address display comprising:
a plastic enclosing compartment three inches in height and ten inches in length;
two rounded tabs with holes and one or more magnets attached to the enclosing compartment;
a side slot;
two tracks;
two outer ridges;
two inner ridges;
a white, translucent plastic address display plate;
user-supplied indicia secured proximate to a front face of the display;
a solar panel;
a battery;
a lighting means positioned behind the display plate providing back lighting to the indicia on the display plate; and
a photo cell switch.

9. (canceled)

10. The user-supplied indicia of claim 8, wherein the indicia comprise user-marked indicia.

11. The user-supplied indicia of claim 8, wherein the indicia comprise printed indicia.

12. (canceled)
